(19) United States
(12) Patent Application Publication
(10) Pub. No.: US 2006/0290211 A1
(43) Pub. Date: Dec. 28, 2006

(54) Cartesian positioning system

(76) Inventors: Koen A. Gieskes, Deposit, NY (US); Stanley W. Janisiewicz, Endwell, NY (US)

Correspondence Address: SCHMEISER, OLSEN & WATTS, 22 CENTURY HILL DRIVE, SUITE 302, LATHAM, NY, 12110, US

(21) Appl. No.: 11/167,422

(22) Filed: Jun. 27, 2005

(51) Int. Cl. H02K 41/00

(52) U.S. Cl. 310/12

(57) ABSTRACT

A positioning system, a robot that employs the positioning system and a method of assembling the robot. The positioning system typically includes a stator and a linear variable reluctance motor that moves along the stator, wherein the stator, besides having an electromagnetic purpose, also acts as the sole structural beam element for the motor to rest upon. The robot employs the positioning system such that subsystems can be attached directly to the motor.

### BACKGROUND OF THE INVENTION

1. Technical Field

This invention relates to positioning systems used in Cartesian robots and, more particularly to a positioning systems incorporating drive systems using linear variable reluctance motors.

2. Related Art

Cartesian robots often comprise multiple positioning systems for moving one or more subsystems, which the robot needs to manipulate, in an X-Y plane. The subsystems are moved typically in both the X and Y-direction, within the plane, but can also just be manipulated in only one of the two axes (i.e., X OR Y-direction) in the X-Y plane. The positioning systems typically comprise a carriage that rides along linear bearings along a structural beam, a first (e.g., “X”) direction. The structural beam, in turn, rides at either, or both, of its ends on linear bearings in a second (e.g., “Y”) direction. The motive force for the system is typically provided by electrical servo motors with either a lead screw or a belt connected thereto or a linear motor that electromagnetically generates a force between the moving parts.

For the drive in the Y-direction, a single sided drive system drives only one end of the structural beam, relying on the stiffness of the Y-bearing to maintain perfect, or near perfect, perpendicularity of the structural beam during its horizontal movement. Alternatively, dual drives may be used to drive both ends of the structural beam at the same time.

A subsystem, which a robot needs to manipulate, may be a tool for picking up and placing objects. The tool may either grip the object or use vacuum to hold the object. For example, robots will manipulate a subsystem comprising a head with vacuum nozzles to assemble printed circuit boards. Another subsystem a robot needs to manipulate may comprise a tool for dispensing material. For example, robots will use a subsystem comprising a dispenser to apply a material on to a surface either by dispensing dots of material or by dispensing the material along a path. The subsystem may also comprise a camera, which the robot needs to move, such that the camera may view various objects of interest. The subsystem the robot needs to manipulate is not limited to the examples described above and may further comprise control devices such as printed circuit boards, valves and the like, necessary to manipulate the tooling. For example, the subsystem may include the ability to turn a vacuum nozzle on and off, to capture and possibly process an image, to move the tool or the subsystem itself in the Z-axis, etc.

As depicted in FIG. 1a, is a lead screw positioning system 10 of the related art. Lead screw positioning system 10 comprises a motor 12, lead screw 16, ball nut 14, carriage 18, structural beam 20, and linear bearing 22. Motor 12 rotates lead screw 16 upon which ball nut 14 is mounted and thus provides the motive force to move ball nut 14 along the linear axis (i.e., parallel to lead screw 16). The top of carriage 18 attaches to ball nut 14 and the bottom of carriage 18 rides on linear bearing 22. FIG. 1b, depicts a variable reluctance positioning system 30 of the related art. Variable reluctance motor (hereinafter VRM) positioning system 30 comprises motor 32, stator 34, carriage 18, two structural beams 20, and two linear bearings 22. Relative motion between motor 32 and stator 34 upon which carriage 18 is mounted provides the motive force to move carriage 18 along the linear axis (i.e., parallel to stator 34). Top and bottom of carriage 18 ride on linear bearing(s) 22. In both the lead screw positioning system 10 and VRM positioning system 30, linear bearing(s) 22 are mounted on structural beam(s) 20. For the lead screw positioning system 10, the combination of lead screw 16/ball nut 14 and linear bearing 22/structural beam 20 stabilize carriage 18 by preventing the rotation of carriage 18 about the X, Y and Z axes and the translation of carriage 18 in the axis perpendicular to the linear axis. In the case of the VRM positioning system 30, the two sets of linear bearings 22/structural beams 20 provide carriage 18 with the same stability.

Mounted to carriage 18 is subsystem 100, in both of the related art systems 10 and 30. In these embodiments, subsystem 100 comprises a head used for picking and placing components onto a printed circuit board using vacuum nozzles 102.

The above-described construction of the positioning system results in a high cost, high weight, and lower speeds because this system requires the use of both the structural beam and bearing(s) to effectively operate.

A need exists for a Cartesian robot incorporating a positioning system that overcomes at least one of the aforementioned and other deficiencies in the art.

### SUMMARY OF THE INVENTION

The present invention overcomes the cost and complexity of building a Cartesian robot by providing a positioning system that is simplified.

A first general aspect, provides a robot comprising:

at least one positioning system comprising a motor and a stator; and

at least one subsystem, wherein said at least one subsystem attaches directly to said motor.

A second general aspect, provides a positioning system comprising:

a stator; and

a linear variable reluctance motor configured for linear movement along said stator, further wherein said stator acts as a structural beam for said motor.

A third general aspect, provides a method for assembling a robot, the steps comprising:

providing at least one positioning system comprising a motor and a stator;

providing at least one subsystem; and

attaching said at least one subsystem directly to said motor.

A fourth general aspect, provides a positioning system for use with a robot said positioning system comprising:

a motor;

a stator, wherein there is a relative motion between said motor and said stator, further wherein said positioning system does not have a separate structural beam.

### BRIEF DESCRIPTION OF THE DRAWINGS

A complete understanding of the present invention may be obtained by reference to the accompanying drawings, when considered in conjunction with the subsequent detailed description, in which:

FIG. 1a is a front view of an assembled lead screw positioning system of the related art;

FIG. 1b is a front view of an assembled variable reluctance motor positioning system of the related art;

FIG. 2 is a top, perspective view of an embodiment of an assembled positioning system, in accordance with the present invention;

FIG. 3 is a front view of the embodiment in FIG. 2, in accordance with the present invention;

FIG. 4 is an end view of the embodiment in FIG. 2, in accordance with the present invention; and

FIGS. 5a through 5e are top views of various embodiments of assembled position systems, in accordance with the present invention.

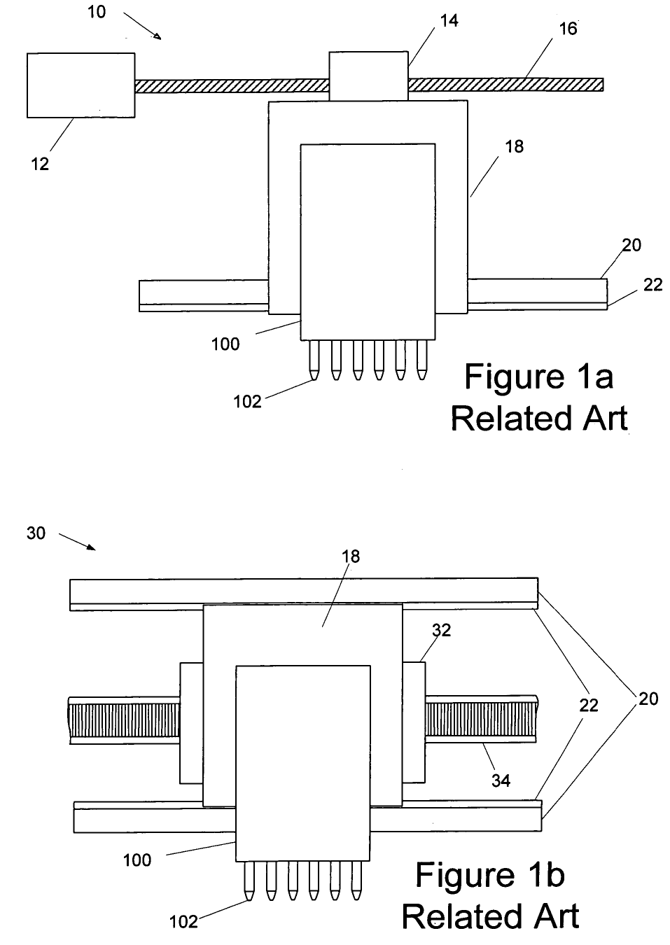

### DETAILED DESCRIPTION OF THE INVENTION

Although certain embodiment of the present invention will be shown and described in detail, it should be understood that various changes and modification may be made without departing from the scope of the appended claims. The scope of the present invention will in no way be limited to the number of constituting components, the materials thereof, the shapes thereof, the relative arrangement thereof, etc. and are disclosed simply as an example of an embodiment. The features and advantages of the present invention are illustrated in detail in the accompanying drawings, wherein like reference numerals refer to like elements throughout the drawings.

The present invention pertains to a Cartesian robot having an X-Y positioning system comprising a drive system that eliminates the need for a separate structural beam(s), a separate attachment carriage, and the linear bearing(s) necessitated by the related art. The inventive apparatus of the drive system comprises a simplified system that includes a linear variable reluctance motor that also acts as a carriage, and a stator that also acts as a structural beam. Therefore, since the motor acts as the carriage, any subsystem that the robot needs to manipulate may be attached directly to the motor. Further, elimination of the carriage in turn eliminates the need for the separate structural beam(s) and the linear bearing(s).

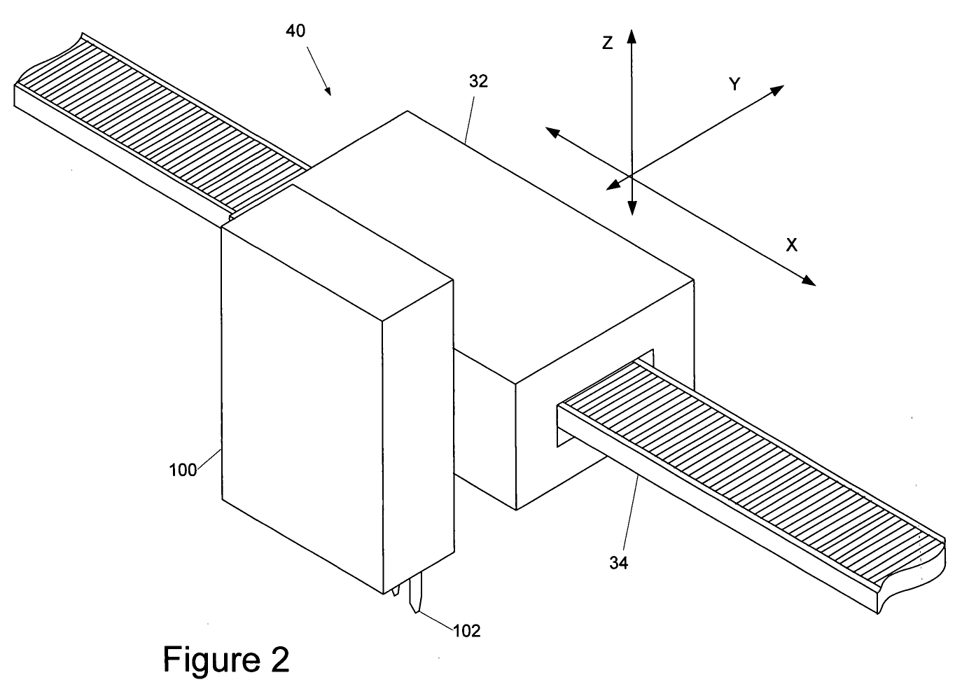

One embodiment of the present invention is shown in various views in FIGS. 2 through 4, and 5a. The system, denoted by a 40, includes a motor 32 and a stator 34. The motor 32 is typically a linear variable reluctance motor 32. Depending on the configuration of the embodiment, either the motor 32 or the stator 34 moves linearly in relationship to the other.

Further attached to the motor 32 is at least one subsystem 100. The subsystem 100 can be one type, or a plurality of types of subsystems 100 which the Cartesian robot needs to move in the X-Y plane. For example, as shown in FIGS. 2 through 5, the subsystem 100 can be, for example, any type suitable for use in a printed circuit board (PCB) component placement machines. The subsystem 100, for example, may comprise a pick and place head, which further comprises a gripper or a vacuum nozzle 102, or subsystem 100 may comprise a material dispenser, a camera, or combinations thereof. Subsystem 100 may also further comprise any control devices such as printed circuit boards, valves and the like necessary to manipulate a gripper, camera, dispenser, etc. Similarly, the subsystem 100 is not limited to subsystems 100 only for PCB component placement machines, but the subsystem 100 or a plurality of subsystems 100 may be any such tooling, or element, that the robot needs to move in the X-Y plane to complete one or more tasks.

One advantage of the present invention includes the capability to directly attach the subsystem 100 to the motor 32, or portion of the motor 32. That is no “interstitial” mechanism (e.g., carriage) is required to attach to the motor 32 and structural beam, that, in turn, is the attachment means for the various subsystems 100. Instead the subsystem(s) 100 may be attached directly to the motor 32 without any intervening carriage, or functionally equivalent or similar mechanism(s).

Still another advantage of the present invention is that the stator 34 does not require a separate structural beam of any sort on which to assist in the linear movement of the motor 32. Thus, the stator 34 acts functionally as the structural beam for the motor 32 to reside and move along, in addition to being an electromagnetic component that interacts with the motor 32 as part of the system 40. The structural beam functionality of the stator 34 ensures perfect, or near perfect, linear movement of the motor 32. Stator 34 rides between bearings 36. The combination of stator 34 with bearings 36, which stabilize subsystem 100 as it moves along the linear axis. Optional bearings 38 provide additional stability to subsystem 100. Other configurations of bearings could also be used to stabilize subsystem 100. For example, bearings (not shown) may be provided along the corners of the stator 34.

Note too that while FIGS. 2 through 4, and 5a, depict the motor 32 moving in a generally X-direction of an X, Y, Z system, clearly in other embodiments, the system 40 may be configured to move in the Y or Z-direction. So too with the configuration of the stator 34 can have other configurations. For example, the stator 34 while lying along the X-axis (see FIG. 2), thus allowing motor 32 to move along the X-axis, alternatively the stator 34 can be configured to lie along the Y-axis, thus allowing Y-axis movement of the motor 32.

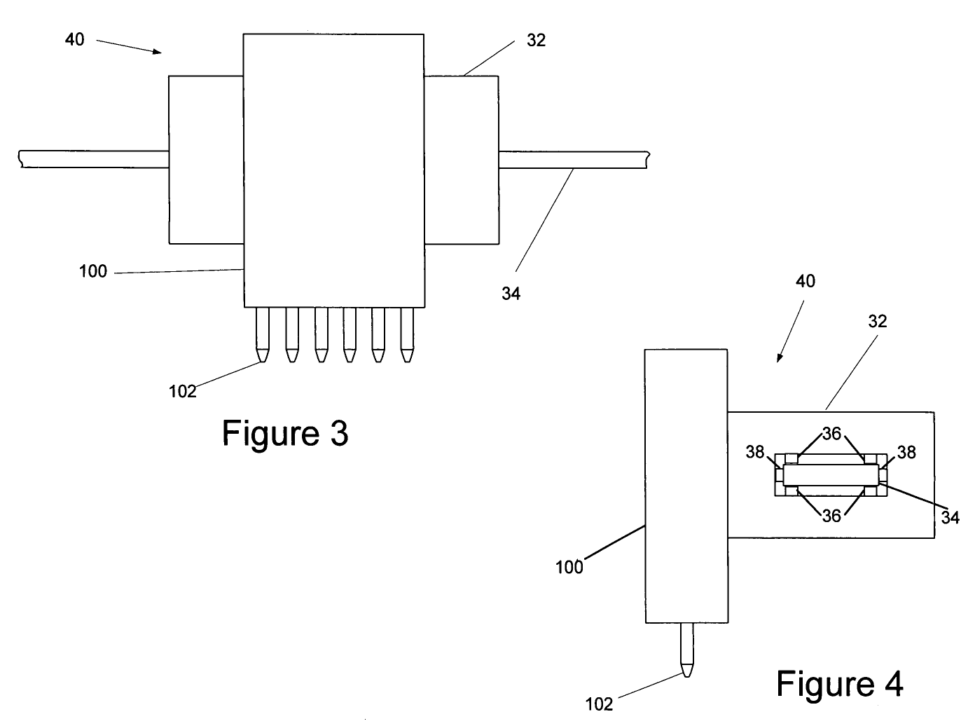

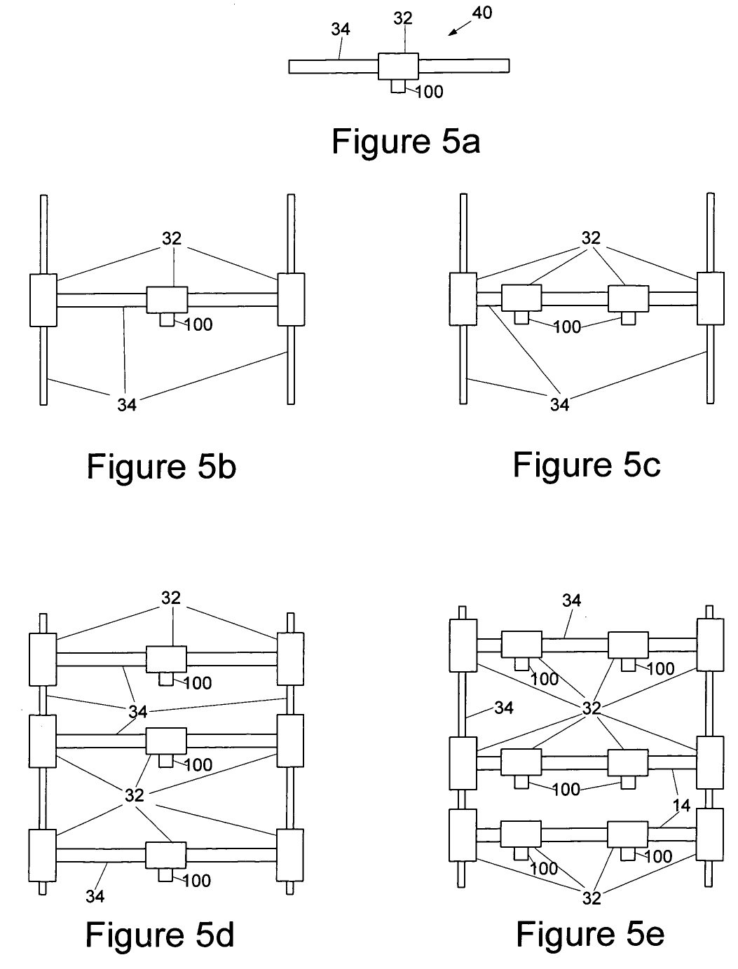

Further, as shown in FIGS. 5b through 5e, additional motor(s) 32 and stator(s) 34 (i.e., additional robotic positioning system(s) 40) may be used. For example, what could be termed a “first” stator 34 (see FIG. 3b) shown can similarly ride on one, or more, “second” motor 32. Thus, allowing the entire “first” motor system 40 to then further move within the X-Y plane along the Y-axis. That is an end of the stator 34 can be attached to a second motor 32 which, in turn, moves along a “second” stator 34. In addition, multiple motor(s) 32 may ride on multiple stators 34 in various combinations as shown in FIGS. 5c through 5e.

Since other modification and changes varied to fit particular operating requirements and environments will be apparent to those skilled in the art, the invention is not considered limited to the example chosen for purposes of disclosure, and covers all changes and modification which do not constitute departures from the true spirit and scope of this invention.

What is claimed is:

1. A robot comprising:
at least one positioning system comprising a motor and a stator; and
at least one subsystem, wherein said at least one subsystem attaches directly to said motor.

2. The robot of claim 1, wherein said motor is a linear motor.

3. The robot of claim 1, wherein said motor is a variable reluctance motor.

4. The robot of claim 1, wherein said stator further acts as a structural beam for said motor.

5. The robot of claim 1, wherein said robot moves in the X-axis.

6. The robot of claim 1, wherein said robot moves in the Y-axis.

7. The robot of claim 1, wherein said at least one subsystem comprises at least one pick and place head.

8. The robot of claim 1, wherein said at least one subsystem comprises at least one dispenser.

9. The robot of claim 1, wherein said at least one subsystem comprises at least one camera.

10. A positioning system comprising:
a stator; and
a linear variable reluctance motor configured for linear movement along said stator, further wherein said stator acts as a structural beam for said motor.

11. The system of claim 10, wherein at least one subsystem attaches directly to said motor.

12. The system of claim 10, wherein said structural beam is integral with said stator.

13. A method for assembling a robot, the steps comprising:
providing at least one positioning system comprising a motor and a stator;
providing at least one subsystem; and
attaching said at least one subsystem directly to said motor.

14. The method of claim 13, wherein said motor is a linear variable reluctance motor.

15. A positioning system for use with a robot said positioning system comprising:
a motor; and
a stator, wherein there is a relative motion between said motor and said stator, further wherein said positioning system does not have a separate structural beam.

16. The system of claim 15, further wherein said positioning system does not include a carriage.

17. The system of claim 15, further wherein said positioning system does not include a linear bearing.

18. The system of claim 15, further wherein at least one subsystem attaches directly to said motor.

19. The system of claim 15, wherein said motor is a linear variable reluctance motor.
